(19) United States
(12) Patent Application Publication
(10) Pub. No.: US 2026/0260867 A1
(43) Pub. Date: Sep. 3, 2026

(54) STACKING DEVICE AND METHOD FOR MANUFACTURING ALL-SOLID-STATE BATTERY USING THE SAME

(71) Applicant: SAMSUNG SDI CO., LTD., Yongin-si, Gyeonggi-do (KR)

(72) Inventor: Daeyoung JI, Yongin-si, Gyeonggi-do (KR)

(73) Assignee: SAMSUNG SDI CO., LTD., Yongin-si, Gyeonggi-do (KR)

(21) Appl. No.: 18/876,104

(22) PCT Filed: Feb. 23, 2024
(86) PCT No.: PCT/KR2024/002397

§ 371 Date: Dec. 17, 2024

(30) Foreign Application Priority Data
Sep. 15, 2023 (KR) 10-2023-0123070

(51) Int. Cl. H01M 4/04; B65H 9/10; B65H 37/04

(52) U.S. Cl. CPC H01M 4/0435; B65H 9/10; B65H 37/04

(57) ABSTRACT

The present invention relates to a stacking device and a method for manufacturing an all-solid-state battery, and more particularly a stacking device including a magazine unit, a sheet transport unit, a sheet alignment unit, and a sheet supply unit. The magazine unit is configured to supply an electrode sheet, the sheet transport unit is configured to pick up the electrode sheet and transport the electrode sheet to the sheet alignment unit, the sheet alignment unit is configured to determine whether the electrode sheet is aligned, the sheet supply unit is configured to stack the electrode sheet on an electrode web, the sheet supply unit includes a stage on which the electrode sheet is loaded and a feeding roller provided on one side of the stage, and the feeding roller is configured such that the electrode sheet is detached from the stage and then attached onto the electrode web.

### TECHNICAL FIELD

The present invention relates to a stacking device and a method for manufacturing an all-solid-state battery using the same, and more particularly, to a stacking device capable of continuously attaching an electrode sheet onto an electrode web and a stacking method.

### BACKGROUND ART

Lately, extensive efforts to develop batteries having high energy density and enhanced safety have been made in response to industrial demand. For example, lithium ion batteries have been put to practical use in automobiles, as well as information related appliances and communication devices. In the field of automobiles, safety is particularly stressed because failures are highly likely to cause harm to lives.

Meanwhile, currently available lithium ion batteries include an electrolyte solution containing a combustible organic dispersion medium, and accordingly, there is a chance of either overheating or fire from short circuits. All-solid-state batteries replacing an electrolyte solution with a solid electrolyte are now being suggested to prevent those concerns above. The all-solid-state batteries use no combustible organic dispersion medium, and may thus have significantly reduced chances of causing fires or explosions even when short circuits take place. Therefore, such all-solid batteries provide far greater safety than lithium ion batteries using electrolyte solutions.

### DISCLOSURE OF THE INVENTION

### Technical Problem

The present invention provides a stacking device for an electrode sheet applicable to a web process.

The present invention also provides a method for manufacturing an all-solid-state battery using the stacking device described above.

### Technical Solution

A stacking device according to an embodiment of the present invention may include a magazine unit, a sheet transport unit, a sheet alignment unit, and a sheet supply unit. The magazine unit may be configured to supply an electrode sheet, the sheet transport unit may be configured to pick up the electrode sheet and transport the electrode sheet to the sheet alignment unit, the sheet alignment unit may be configured to determine whether the electrode sheet is aligned, the sheet supply unit may be configured to stack the electrode sheet on an electrode web, the sheet supply unit may include a stage on which the electrode sheet is loaded and a feeding roller provided on one side of the stage, and the feeding roller may be configured such that the electrode sheet is detached from the stage and then attached onto the electrode web.

A method for manufacturing an all-solid-state battery according to another embodiment of the present invention may include subjecting an electrode web to travel along a first direction, supplying an electrode sheet onto a stage, inverting the stage such that the electrode sheet faces the electrode web, and attaching the electrode sheet onto the electrode web. The electrode sheet may be detached from the stage and attached onto the electrode web through a feeding roller provided on one side of the stage.

### Advantageous Effects

A stacking device according to the present invention may effectively supply and attach an electrode sheet onto an electrode web. Accordingly, alignment between the electrode sheet and the electrode web may be improved. A method for manufacturing an all-solid-state battery according to the present invention may involve staking and roll-pressing an electrode through a web process. Subsequently, an all-solid-state battery may have improved productivity.

### BRIEF DESCRIPTION OF THE DRAWINGS

FIG. 1 is a cross-sectional view for describing an all-solid-state battery according to embodiments of the present invention;

FIG. 2 is a perspective view for describing a stacking device for an all-solid-state battery according to embodiments of the present invention; and

FIGS. 3 through 7 are perspective views for describing a method for manufacturing an all-solid-state battery according to embodiments of the present invention.

### MODE FOR CARRYING OUT THE INVENTION

In order to sufficiently understand the configuration and effects of the present invention, preferred embodiments of the present invention will be described with reference to the accompanying drawings. It should be noted, however, that the present invention is not limited to the following embodiments, and may be implemented in various forms and variously modified. The embodiments herein are provided so that present invention will be thorough and complete and will fully convey the scope of the present invention to those skilled in the art.

Herein, it will be understood that when a component is referred to as being on another component, the component may be directly on another component, or an intervening third component may be present. In addition, in the drawings, thicknesses of components are exaggerated for effectively describing technical contents. Like reference numerals refer to like elements throughout.

The embodiments described herein will be explained with reference to the cross-sectional views, plan views, and/or perspective views as ideal example views of the present invention. Although the terms such as first, second, and third are used to describe various components in various embodiments herein, the components should not be limited to these terms. These terms are used only to distinguish one component from another component. Embodiments described and exemplified herein include complementary embodiments thereof.

Terms used herein are not for limiting the present invention but for describing the embodiments. As used herein, the singular forms include the plural forms as well, unless the context clearly indicates otherwise. The meaning of “comprises” and/or “comprising” used herein does not exclude the presence or addition of one or more other components besides a mentioned component.

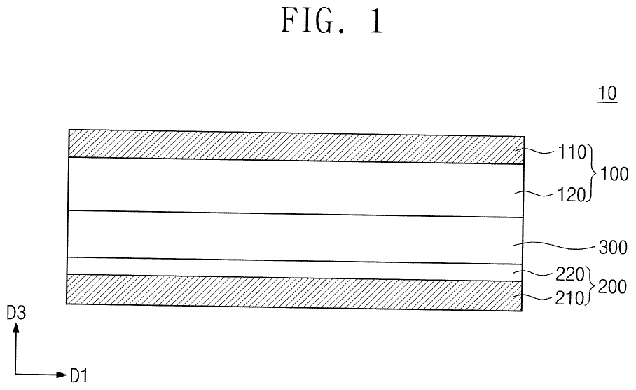

FIG. 1 is a cross-sectional view for describing an all-solid-state battery according to embodiments of the present invention. Referring to FIG. 1, an all-solid-state battery 10 may include a positive electrode layer 100, a negative electrode layer 200 facing the positive electrode layer 100, and a solid electrolyte layer 300 disposed between the positive electrode layer 100 and the negative electrode layer 200. However, the embodiment of the present invention is not limited thereto, and the all-solid-state battery 10 may further include an additional functional layer disposed between the positive electrode layer 100 and the solid electrolyte layer 300 or between the negative electrode layer 200 and the solid electrolyte layer 300, such as an adhesion enhancing layer.

The positive electrode layer 100 may include a positive electrode current collector 110 and a positive electrode active material layer 120 on the positive electrode current collector 110. The positive electrode active material layer 120 may include a positive electrode active material, a solid electrolyte, a conductive material, and a binder.

The positive electrode current collector 110 may provide a reference surface on which the positive electrode active material layer 120 is disposed. The positive electrode current collector 110 may be in the form of a plate or a foil. For example, the positive electrode current collector 110 may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Unlike what is shown in FIG. 1, the positive electrode current collector 110 may not be provided in an embodiment of the present invention. Although not shown, a carbon layer having a thickness of 0.1 μm to 4 μm may be further disposed between the positive electrode current collector 110 and the positive electrode active material layer 120 to increase binding strength between the positive electrode current collector 110 and the positive electrode active material layer 120.

The positive electrode active material may be a material capable of reversibly absorbing and desorbing lithium ions. For example, the positive electrode active material may include a lithium transition metal oxide such as lithium cobalt oxide (LCO), lithium nickel oxide, lithium nickel cobalt oxide, lithium nickel cobalt aluminum oxide (NCA), lithium nickel cobalt manganate (NCM), lithium manganate, or lithium iron phosphate; nickel sulfide; copper sulfide; lithium sulfide; iron oxide; or vanadium oxide, but the embodiment of the present invention is not limited thereto. The positive electrode active material may be used alone or may be a mixture of two or more types.

The lithium transition metal oxide may be, for example, a compound represented by any one among LiₐA_{1-b}B_{b}D₂ (0.90≤a≤1, 0≤b≤0.5), LiₐE_{1-b}B_{b}O_{2-c}D_{c} (0.90≤a≤1, 0≤b≤0.5, 0≤c≤0.05), LiE_{2-b}B_{b}O_{4-c}D_{c} (0≤b≤0.5, 0≤c≤0.05), LiₐNi_{1-b-c}Co_{b}B_{c}D_{α} (0.90≤a≤1, 0≤b≤0.5, 0c≤0.05, 0<α<2), LiₐNi_{1-b-c}Co_{b}B_{c}O_{2-α}F_{α} (0.90≤a≤1, 0≤b≤0.5, 0≤c≤0.05, 0<α<2), LiₐNi_{1-b-c}Mn_{b}B_{c}D_{α} (0.90≤a≤1, 0≤b≤0.5, 0≤c≤0.05, 0<α≤2), LiₐNi_{1-b-c}Mn_{b}B_{c}O_{2-α}F_{α} (0.90≤a≤1, 0≤b≤0.5, 0≤c≤0.05, 0<α<2), LiₐNi_{b}E_{c}G_{d}O₂ (0.90≤a≤1, 0≤b≤0.9, 0≤c≤0.5, 0.001≤d≤0.1), LiₐNi_{b}Co_{c}Mn_{d}GeO₂ (0.90≤a≤1, 0≤b≤0.9, 0≤c≤0.5, 0≤d≤0.5, 0.001≤e≤0.1), LiₐNiG_{b}O₂ (0.9≤a≤1, 0.001≤b≤0.1), LiₐCoG_{b}O₂ (0.90≤a≤1, 0.001≤b≤0.1), LiₐMnG_{b}O₂ (0.90≤a≤1, 0.001≤b≤0.1), LiₐMn₂GbO₄ (0.90≤a≤1, 0.001≤b≤0.1), QO₂, QS₂, LiQS₂, V₂O₅, LiV₂O₅, LiIO₂, LiNiVO₄, Li_{3-f}J₂(PO₄)₃ (0≤f≤2), Li_{3-f}Fe₂(PO₄)₃ (0≤f≤2), and LiFePO₄. In the compound, capital “A” is nickel (Ni), cobalt (Co), manganese (Mn), or a combination thereof; capital “B” is aluminum (Al), nickel (Ni), cobalt (Co), manganese (Mn), chromium (Cr), iron (Fe), magnesium (Mg), strontium (Sr), vanadium (V), a rare earth element, or a combination thereof; capital “D” is oxygen (O), fluorine (F), sulfur (S), phosphorus (P), or a combination thereof, capital “E” is cobalt (Co), manganese (Mn), or a combination thereof; capital “F” is fluorine (F), sulfur (S), phosphorus (P), or a combination thereof; capital “G” is (Al), chromium (Cr), manganese (Mn), iron (Fe), magnesium (Mg), lanthanum (La), cerium (Ce), strontium (Sr), vanadium (V), or a combination thereof; capital “Q” is titanium (Ti), molybdenum (Mo), manganese (Mn), or a combination thereof; capital “I” is chromium (Cr), vanadium (V), iron (Fe), scandium (Sc), yttrium (Y), or a combination thereof; and capital “J” is vanadium (V), chromium (Cr), manganese (Mn), cobalt (Co), nickel (Ni), copper (Cu), or a combination thereof.

The positive electrode active material may include, for example, a lithium salt of the transition metal oxide that has a layered rock salt type structure among the examples of the lithium transition metal oxide. For example, the “layered rock salt type structure” indicates a structure in which oxygen atomic layers and metal atomic layers are alternately arranged regularly in a <111> direction of a cubic rock salt type structure, and as a result, each atomic layer forms a two-dimensional plane. The “cubic rock salt type structure” indicates a sodium chloride (NaCl) type structure, which is one type of crystal structures, and in particular, a structure in which face centered cubic (fcc) lattices formed by respective anions and cations are misaligned with respect to each other by ½ of the ridge of a unit lattice. The lithium transition metal oxide having this layered rock salt type structure may be a ternary lithium transition metal oxide, such as LiNiₓCo_{y}Al_{z}O₂ (NCA) or LiNiₓCo_{y}Mn_{z}O₂ (NCM) (0<x<1, 0<y<1, 0<z<1, x+y+z=1). When the positive electrode active material includes a ternary lithium transition metal oxide having a layered rock salt type structure, the all-solid-state battery 10 may have greater energy density and improved thermal stability.

The above-described compounds included in the positive electrode active material may be covered by a coating layer (not shown). The positive electrode active material may also be used as a mixture of the above-described compounds and a compound to which a coating layer is added. Meanwhile, the coating layer added to a surface of the positive electrode active material may include, for example, oxide, hydroxide, oxyhydroxide, oxycarbonate, or hydroxycarbonate of the following coating elements. The compounds forming the coating layer may be amorphous or crystalline. The coating elements included in the coating layer may be Mg, Al, Co, K, Na, Ca, Si, Ti, V, Sn, Ge, Ga, B, As, Zr, or a mixture thereof. The coating layer may include, for example, Li₂O—ZrO₂ (LZO). The coating layer may be formed using any method that does not adversely affect the physical properties of the positive electrode active material. For example, the coating layer may be formed using a spray coating method or a dipping method.

When the positive electrode active material includes nickel (Ni) as a ternary lithium transition metal oxide such as NCA or NCM, the capacity density of the all-solid-state battery 10 may increase, and thus the metal elution of the positive electrode active material may be reduced in a charged state. Accordingly, the all-solid-state battery 10 may have improved cycle characteristics in a charged state. Meanwhile, the “cycle characteristics” are characteristics that indicate the degree to which the all-solid-state battery 10 is deteriorated due to charging/discharging of the all-solid-state battery 10, and in an all-solid-state battery 10 having high cycle characteristics, the degree of deterioration caused by charging/discharging may be insignificant, and in an all-solid-state battery 10 having low cycle characteristics, the degree of deterioration caused by charging/discharging may be significant.

The shape of the positive electrode active material may include, for example, particle shapes such as spheres and ellipsoids. The particle size and content of the positive electrode active material are not particularly limited.

The solid electrolyte may include a sulfide-based solid electrolyte having excellent lithium ion conductivity characteristics. The sulfide-based solid electrolyte may include, for example, at least one selected from Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and capital “Z” is one of Ge, Zn, or Ga), Li₂S—GeS₂, Li₂S—SiS₂—Li₃PO₄, Li₂S—SiS₂—LiₚMO_{q} (where p and q are positive numbers, and “M” is one of P, Si, Ge, B, Al, Ga, or In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2).

The sulfide-based solid electrolyte may be an argyrodite-type compound containing at least one selected from, for example, Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound containing at least one selected from, for example, Li₆PS₅Cl, Li₆PS₅Br, and Li₆PS₅I. The argyrodite-type solid electrolyte may have a density of 1.5 g/cc to 2.0 g/cc. The argyrodite-type solid electrolyte, when having a density of 1.5 g/cc or greater, may allow all-solid-state batteries to have reduced internal resistance and prevent solid electrolyte membranes from showing defects such as penetration and short-circuits caused by formation of lithium dendrites. The solid electrolyte may have an elastic modulus of, for example, 15 GPa to 35 GPa.

The solid electrolyte included in the positive electrode active material layer 120 may have a smaller average (median) particle size (D50) than the solid electrolyte included in the solid electrolyte layer 300. For example, the average (median) particle size (D50) of the solid electrolyte included in the positive electrode active material layer 120 may be 90% or less, 80% or less, 70% or less, 60% or less, 50% or less, 40% or less, 30% or less, or 20% or less of the average (median) particle size (D50) of the solid electrolyte included in the solid electrolyte layer 300. Meanwhile, the average (median) particle size (D50) may be a median diameter measured using a laser particle size distribution meter.

The positive electrode active material layer 120 may include a conductive material. The conductive material has conductivity without causing chemical changes in the all-solid-state battery 10, and may thus increase the conductivity of the positive electrode active material and the solid electrolyte. The conductive material may include a carbon-based material. The conductive material may include, for example, at least one selected from graphite, carbon black, acetylene black, carbon nanofibers, and carbon nanotubes.

The positive electrode active material layer 120 may further include a binder. The binder may bond the positive electrode active material, the solid electrolyte, and the conductive material contained in the positive electrode active material layer 120, and may include a material designed to improve bonding strength with the positive electrode current collector 110. The binder may include, for example, polyvinylidene fluoride, styrene butadiene rubber (SBR), polytetrafluoroethylene, polyvinylidenefluoride, vinylidene fluoride/hexafluoropropylene copolymer, polyacrylonitrile, or polymethyl methacrylate.

The positive electrode active material layer 120 may include 85 parts by weight to 92 parts by weight of the positive electrode active material with respect to 100 parts by weight of the positive electrode active material, the solid electrolyte, the conductive material, and the binder. The positive electrode active material layer 120 may include 0.5 parts by weight to 1.5 parts by weight of the binder.

In the positive electrode active material layer 120, the conductive material may be present in an amount of 1 part by weight to 50 parts by weight with respect to 100 parts by weight of the solid electrolyte. When the conductive material is present in an amount of less than 1 part by weight with respect to 100 parts by weight of the solid electrolyte, the positive electrode active material layer 120 may have reduced electrical conductivity. When the conductive material is present in an amount of greater than 50 parts by weight with respect to 100 parts by weight of the solid electrolyte, the proportion of the conductive material goes up too high, and thus a coating layer covering a surface of the solid electrolyte may not be properly formed.

According to embodiments, the positive electrode active material layer 120 may further include at least one additive selected from the group consisting of a filler, a coating agent, a dispersant, and an ion conductive auxiliary agent, in addition to the positive electrode active material, the solid electrolyte, the conductive material, and the binder described above.

The solid electrolyte layer 300 may be disposed between the positive electrode layer 100 and the negative electrode layer 200 and may include a sulfide-based solid electrolyte having excellent lithium ion conductivity characteristics. The solid electrolyte included in the solid electrolyte layer 300 may be the same as or different from any one of the materials that may be included in the solid electrolyte included in the positive electrode active material layer 120 described above.

The solid electrolyte layer 300 of an embodiment may include a sulfide-based solid electrolyte. The sulfide-based solid electrolyte may be prepared by subjecting starting materials (e.g., Li₂S, P₂S₅) to melt-quenching or mechanical milling. In addition, subsequently, the resulting product may be heat-treated. The solid electrolyte may be amorphous, crystalline, or a mixture thereof. In addition, the solid electrolyte may include at least sulfur (S), phosphorus (P), and lithium (Li), as component elements among the sulfide-based solid electrolyte materials described above. For example, the solid electrolyte may be a material containing Li₂S—P₂S₅. When the material containing Li₂S—P₂S₅ is used as a sulfide-based solid electrolyte material that forms the solid electrolyte, a mixing molar ratio of Li₂S and P₂S₅ (Li₂S:P₂S₅) is, for example, in a range of 50:50 to 90:10.

The sulfide-based solid electrolyte may be an argyrodite-type compound containing at least one selected from, for example, Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound containing at least one selected from, for example, Li₆PS₅Cl, Li₆PS₅Br, and Li₆PS₅I. The argyrodite-type solid electrolyte may have a density of 1.5 g/cc to 2.0 g/cc. The argyrodite-type solid electrolyte, when having a density of 1.5 g/cc or greater, may allow all-solid-state batteries to have reduced internal resistance and prevent solid electrolyte membranes from showing defects such as penetration and short-circuits caused by formation of lithium dendrites. The solid electrolyte has an elastic modulus of, for example, 15 GPa to 35 GPa.

The solid electrolyte layer 300 may further include a binder. The binder in the solid electrolyte layer 300 is, for example, styrene butadiene rubber (SBR), polytetrafluoroethylene, polyvinylidene fluoride, and polyethylene, but the embodiment of the present invention is not limited thereto. The binder of the solid electrolyte layer 300 may be the same as or different from the binder included in the positive electrode active material layer 120 or the binder included in the negative electrode coating layer 220.

The negative electrode layer 200 may include a negative electrode current collector 210 and a negative electrode coating layer 220 on the negative electrode current collector 210. The negative electrode current collector 210 may provide a reference surface on which the negative electrode coating layer 220 is disposed. For example, the negative electrode current collector 210 may include a material that is not reactive with lithium, i.e., does not form either an alloy or a compound with lithium. For example, the negative electrode current collector 210 may include at least one metal selected from the group consisting of copper (Cu), stainless steel, titanium (Ti), iron (Fe), cobalt (Co), and nickel (Ni). The negative electrode current collector 210 may have a thickness of 1 μm to 20 μm, more specifically 5 μm to 15 μm, more specifically 7 μm to 10 μm.

The negative electrode current collector 210 may be composed of one of the above-described metals, or may include an alloy of two or more metals or a coating material. The negative electrode current collector 210 may be, for example, in the form of a plate or a foil. Meanwhile, in an embodiment, the negative electrode current collector 210 may not be provided.

The negative electrode coating layer 220 may allow lithium metal to grow between the negative electrode coating layer 220 and the negative electrode current collector 210 when the all-solid-state battery 10 is charged. The negative electrode coating layer 220 may serve as a protection layer for lithium metal and also inhibit the deposition and growth of lithium dendrites.

The negative electrode coating layer 220 may include metal and carbon. For example, the negative electrode coating layer 220 may include at least one metal selected from the group consisting of gold (Au), platinum (Pt), palladium (Pd), silicon (Si), silver (Ag), aluminum (Al), bismuth (Bi), tin (Sn), and zinc (Zn). The negative electrode coating layer 220 may include at least one carbon selected from the group consisting of carbon black, acetylene black, furnace black, ketjen black, and graphene. In an embodiment, the negative electrode coating layer 220 may include a mixture of carbon black and silver (Ag).

The negative electrode coating layer 220 may further include other additives in addition to metal and carbon. The negative electrode coating layer 220 may further include at least one additive selected from the group consisting of, for example, a binder, a filler, a coating agent, a dispersant, and an ion conductive auxiliary agent.

The negative electrode coating layer 220 may have a smaller thickness than the positive electrode active material layer 120. The thickness of the negative electrode coating layer 220, is, for example, 50% or less, 40% or less, 30% or less, 20% or less, 10% or less, or 5% or less of the thickness of the positive electrode active material layer 120. The negative electrode coating layer 220 may have a thickness of, for example, 1 μm to 20 μm, 2 μm to 10 μm, or 3 μm to 7 μm. When the negative electrode coating layer 220 is too thin, the lithium dendrites formed between the negative electrode coating layer 220 and the negative electrode current collector 210 break down the negative electrode coating layer 220, and this may cause the all-solid-state battery 10 to have degraded cycle characteristics. When the negative electrode coating layer 220 is too thick, the all-solid-state battery 10 has reduced energy density and greater internal resistance due to the negative electrode coating layer 220, and this may cause the all-solid-state battery 10 to have degraded cycle characteristics.

Meanwhile, although not shown, a carbon layer designed to improve adhesion between the negative electrode coating layer 220 and the solid electrolyte layer 300 may be further included.

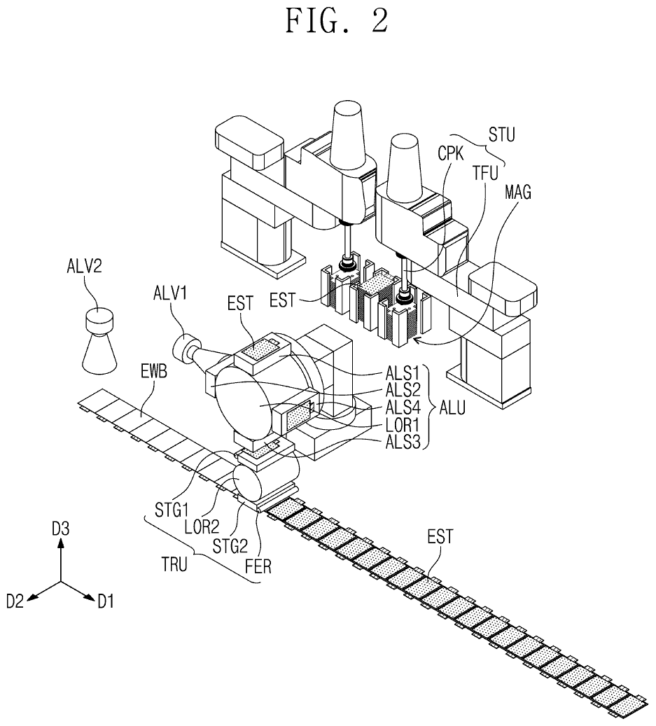

FIG. 2 is a perspective view for describing a stacking device for an all-solid-state battery according to embodiments of the present invention.

Referring to FIG. 2, the stacking device may include a magazine unit MAG, a sheet transport unit STU, a sheet alignment unit ALU, and a sheet supply unit TRU. A plurality of electrode sheets EST may be loaded into the magazine unit MAG. The magazine unit MAG may be configured to sequentially supply the plurality of electrode sheets EST.

Each of the electrode sheets EST loaded into the magazine unit MAG may be a positive electrode layer 100 or a negative electrode layer 200 described above with reference to FIG. 1. In an embodiment of the present invention, the electrode sheet EST may include the positive electrode layer 100 or the negative electrode layer 200 and a solid electrolyte layer 300 (FIG. 1) formed thereon. In another embodiment of the present invention, a solid electrolyte layer may not be provided in the electrode sheet EST.

The sheet transport unit STU may include a sheet picking portion CPK and a conveyor TFU. The sheet picking portion CPK may be configured to pick up the electrode sheet EST supplied from the magazine unit MAG. For example, the sheet picking portion CPK may include an adsorption means capable of adsorbing the electrode sheet EST.

The conveyor TFU may be configured to transfer the picked electrode sheet EST to the sheet alignment unit ALU. For example, the conveyor TFU may be shaped as a robot arm and may transfer the electrode sheet EST from the magazine unit MAG to the sheet alignment unit ALU.

The sheet alignment unit ALU may include first to fourth alignment stages ALS1 to ALS4 and a first rotation unit LOR1. The first rotation unit LOR1 may be shaped as a roller or a drum that rotates counterclockwise. The first to fourth alignment stages ALS1 to ALS4 may be disposed at regular intervals along an outer surface of the first rotation unit LOR1. The first rotation unit LOR1 may be configured to move the first to fourth alignment stages ALS1 to ALS4 counterclockwise.

Each of the first to fourth alignment stages ALS1 to ALS4 may be configured to load the electrode sheet EST. For example, the electrode sheet EST loaded on the first alignment stage ALS1 may move counterclockwise through the first rotation unit LOR1.

A first alignment measuring portion ALV1 may be provided adjacent to the sheet alignment unit ALU. The first alignment measuring portion ALV1 may be configured to measure alignment between the alignment stages ALS1 to ALS4 and the electrode sheet EST. The first alignment measuring portion ALV1 may check the alignment between the electrode sheet and the alignment stages through vision.

The sheet supply unit TRU may be positioned below the third alignment stage ALS3. The sheet supply unit TRU may include first and second stages STG1 and STG2 and a second rotation unit LOR2. The second rotation unit LOR2 may be shaped as a roller or a drum that rotates counterclockwise or clockwise. The first and second stages STG1 and STG2 may be disposed at regular intervals along an outer surface of the second rotation unit LOR2. The second rotation unit LOR2 may be configured to rotate the first and second stages STG1 and STG2 such that the first and second stages STG1 and STG2 are repeatedly inverted vertically.

Each of the first and second stages STG1 and STG2 may be configured to load the electrode sheet EST. For example, the electrode sheet EST loaded from the sheet alignment unit ALU to the first stage STG1 may move to a position of the second stage STG2 while being rotated through the second rotation unit LOR2. In this case, the first stage STG1 and the electrode sheet EST are inverted, and thus the electrode sheet EST may face an electrode web EWB.

The sheet supply unit TRU may be configured to move in a third direction D3 in a stamping manner. The electrode sheet EST facing the electrode web EWB may be stamped (or transferred) onto the electrode web EWB as the sheet supply unit TRU moves downward.

A feeding roller FER may be provided on one side of each of the first and second stages STG1 and STG2. The feeding roller FER may be configured such that the electrode sheet EST provided on the electrode web EWB is smoothly detached from the stage STG1 and STG2.

The electrode web EWB may travel along a first direction D1. The electrode web EWB may be supplied from an unwinding electrode reel. The electrode web EWB may be provided below the sheet supply unit TRU while moving along the first direction D1.

The electrode web EWB may include the negative electrode layer 200 or the positive electrode layer 100 described above with reference to FIG. 1. In an embodiment of the present invention, when the electrode sheet EST includes the positive electrode layer 100, the electrode web EWB may include a plurality of negative electrode layers 200 arranged along the first direction D1. For example, the plurality of negative electrode layers 200 may be connected to form one negative electrode layer 200. In another embodiment of the present invention, when the electrode sheet EST includes a negative electrode layer 200, the electrode web EWB may include a plurality of positive electrode layers 100 arranged along the first direction D1. For example, the plurality of positive electrode layers 100 may be connected to form one positive electrode layer 100.

The electrode sheet EST may be a positive electrode and the electrode web EWB may be a negative electrode, or the electrode sheet EST may be a negative electrode and the electrode web EWB may be a positive electrode. Although not particularly limited, in embodiments, which will be described later, as an example, the electrode sheet EST is presented as a positive electrode and the electrode web EWB is presented as a negative electrode.

A second alignment measuring portion ALV2 may be provided on the electrode web EWB. The second alignment measuring portion ALV2 may check the alignment of the electrode web EWB through vision.

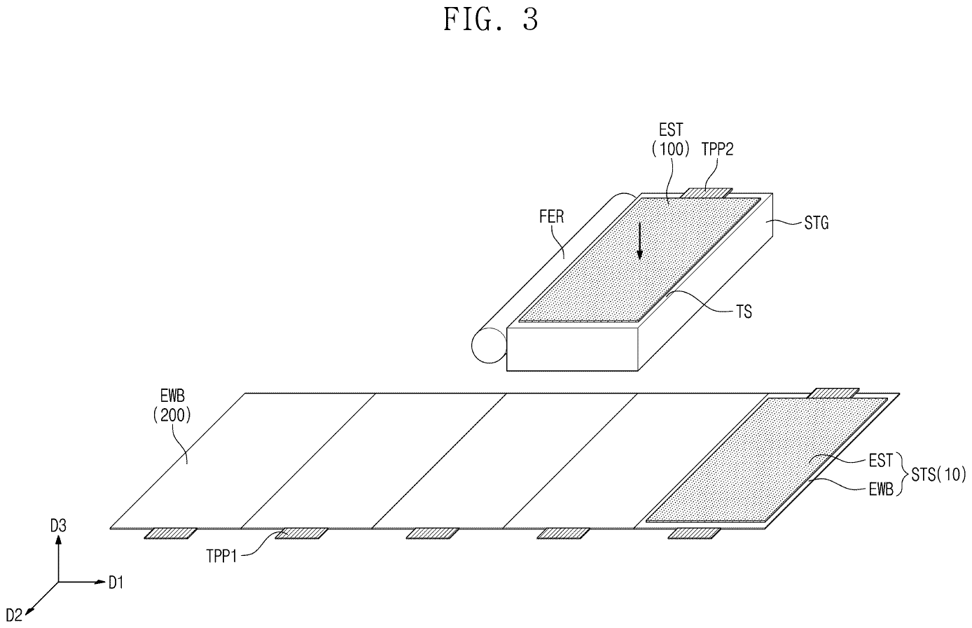

FIGS. 3 through 7 are cross-sectional views for describing a method for manufacturing an all-solid-state battery according to embodiments of the present invention. In the present embodiment, a method for manufacturing the all-solid-state battery of FIG. 1, using the above-described stacking device of FIG. 2 will be described.

Referring to FIG. 3, the electrode web EWB may travel along the first direction D1. The electrode web EWB may include a negative electrode layer 200. Specifically, the electrode web EWB may include a negative electrode current collector 210 and a negative electrode coating layer 220 described in FIG. 1. The electrode web EWB may further include first electrode tabs TPP1. The first electrode tabs TPP1 may be provided at regular intervals along the first direction D1.

Then electrode sheet EST may be provided on the electrode web EWB through a sheet supply unit of the stacking device of FIG. 2. The electrode web EWB and the electrode sheet EST stacked thereon may form one stacking structure STS. The stacking structure STS may be manufactured into the all-solid-state battery 10 described in FIG. 1 through a subsequent process.

Referring back to FIG. 3, the electrode sheet EST may be provided on one side TS of a stage STG. The electrode sheet EST may include a positive electrode layer 100. Specifically, the electrode sheet EST may include a positive electrode current collector 110 and a positive electrode active material layer 120 described in FIG. 1. The electrode sheet EST may further include a second electrode tab TPP2. The electrode sheet EST may be provided from the sheet alignment unit ALU (FIG. 2) onto the stage STG. A feeding roller FER may be provided on one side of the stage STG. The feeding roller FER may be adjacent to the electrode sheet EST in an opposite direction to the first direction D1.

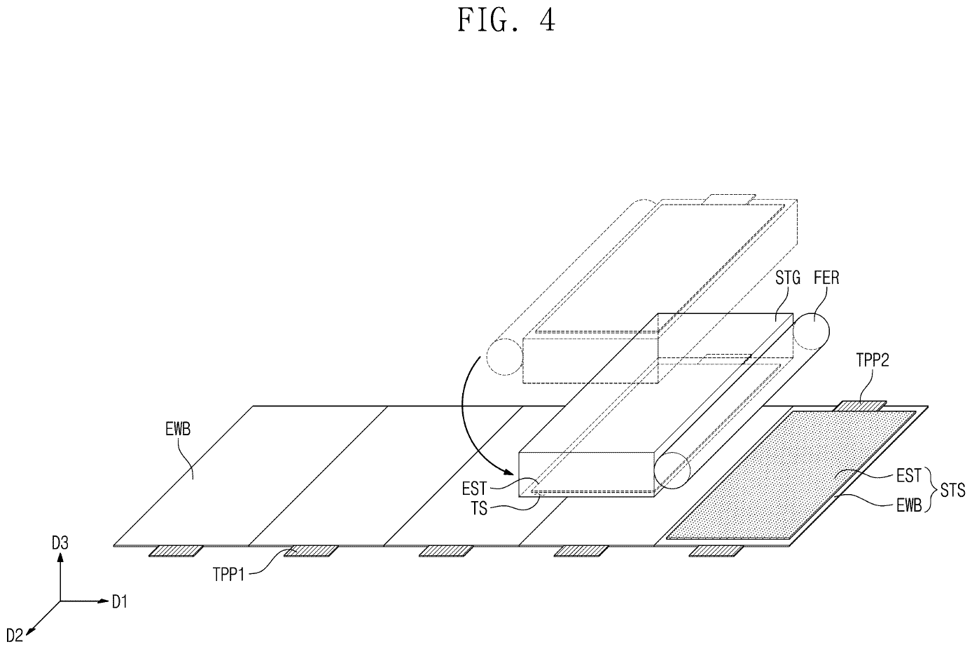

Referring to FIG. 4, the stage STG may be rotated and inverted. Accordingly, the one side TS of the stage STG may face the electrode web EWB. For example, the stage STG may be rotated 180 degrees through the second rotation unit LOR2 of FIG. 2. As the stage STG rotates, the electrode sheet EST may be inverted. The inverted electrode sheet EST may be adjacent to the electrode web EWB and may face the electrode web EWB.

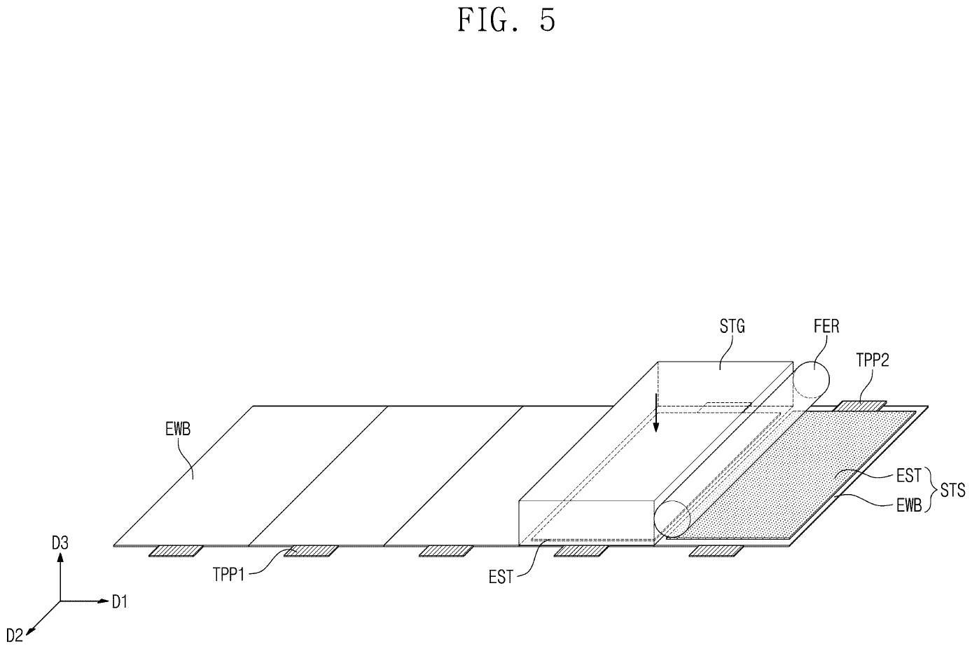

Referring to FIG. 5, the stage STG may move downward, and thus the electrode sheet EST may contact the electrode web EWB. The electrode sheet EST may be stacked (or settled) on the electrode web EWB.

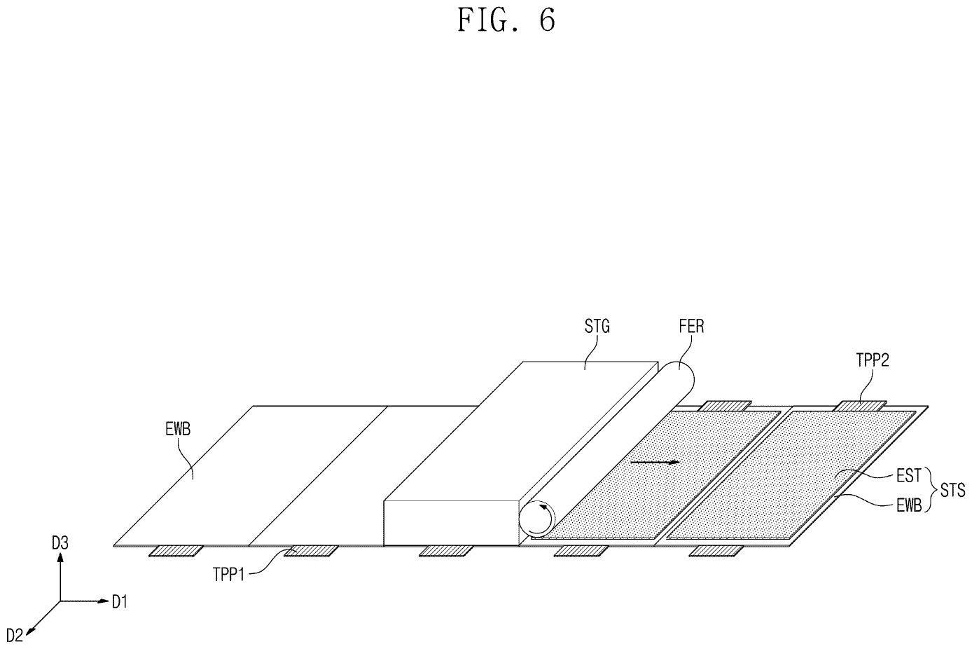

Referring to FIG. 6, the feeding roller FER may discharge the electrode sheet EST from the stage STG while rotating counterclockwise. The electrode web EWB travels in the first direction D1, and the feeding roller FER may rotate accordingly. Subsequently, the electrode sheet EST may be stably attached onto the electrode web EWB and may thus move together with the electrode web EWB in the first direction D1.

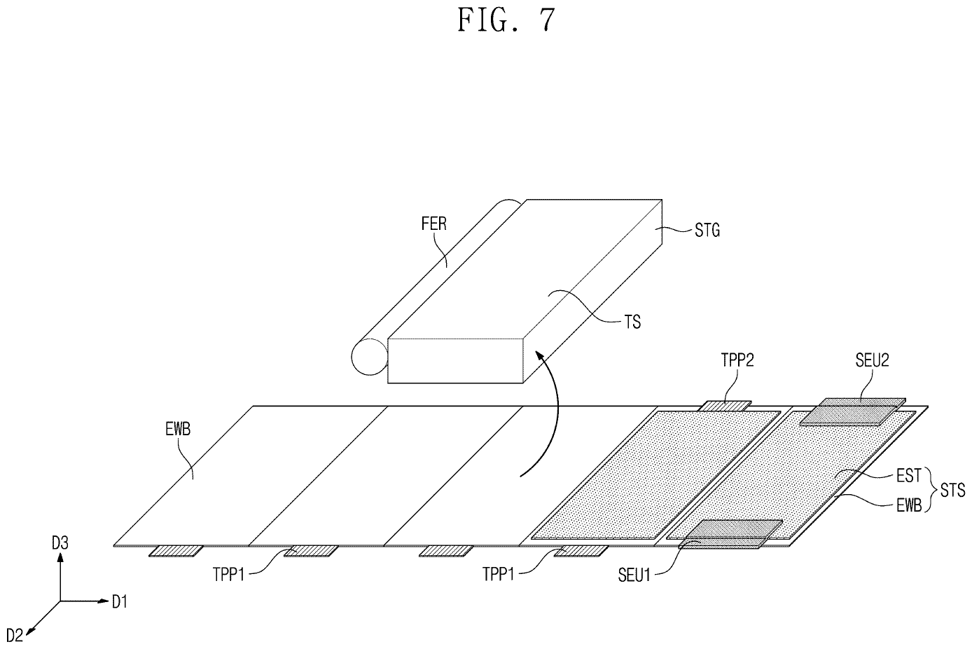

Referring to FIG. 7, the stage STG may be rotated and inverted. This allows the one side TS of the stage STG to be exposed upward again. The stage STG may return to the position of FIG. 3. The process of FIG. 3 through FIG. 6 may then be repeated.

In an embodiment of the present invention, after the staking of the electrode sheet EST on the electrode web EWB, first and second sealing members SEU1 and SEU2 may each be provided at both ends of the stacking structure STS. The first sealing member SEU1 may both cap the first electrode tab TPP1 and fix the electrode web EWB and the electrode sheet EST. The second sealing member SEU2 may both cap the second electrode tab TPP2 and fix the electrode web EWB and the electrode sheet EST. The first and second sealing members SEU1 and SEU2 may be configured to maintain alignment between the electrode sheet EST and the electrode web EWB during subsequent processes. The first and second sealing members SEU1 and SEU2 may be removed during subsequent processes.

According to embodiments of the present invention, as a subsequent process, a pressing process may be performed on the stacking structure STS that travels on the web in the first direction D1. Through the above pressing process, a solid electrolyte layer 300 may be densified. Through the pressing process, interface resistance between the solid electrolyte layer 300 and the electrode layers 100 and 200 may be reduced. In an embodiment, the pressing process may include roll pressing. The manufacturing process of the all-solid-state battery according to the present invention may be performed as a web process that travels in the first direction. Accordingly, stacked structures STS may be continuously pressed through the roll pressing.

A notching process may be performed after the pressing process. The web may be divided into a plurality of stacked structures STS through the notching process. The all-solid-state battery 10 of FIG. 1 may be manufactured using the cut stacked structures STS.

According to embodiments of the present invention, the electrode sheet EST may be stably attached onto a traveling electrode web EWB by stamping an inverted stage STG onto the electrode web EWB. That is, instead of stacking the electrode sheet EST by tracking the traveling electrode web EWB through the stage STG, the electrode sheet EST may be stacked on the electrode web EWB by stamping the stage STG after inversion. Accordingly, the stacking operation is simplified, and the alignment between the electrode web EWB and the electrode sheet EST may be improved.

According to embodiments of the present invention, the electrode sheet EST may be stably attached onto the traveling electrode web EWB through the feeding roller FER provided on one side of the stage STG. While the electrode sheet EST is transferred from the stage STG to the electrode web EWB, misalignment may take place between the electrode sheet EST and the electrode web EWB due to the traveling of the electrode web EWB. However, the present invention may naturally transfer the electrode sheet EST from the stage STG to the electrode web EWB even while the electrode web EWB is traveling, through the feeding roller FER. Accordingly, the alignment between the electrode web EWB and the electrode sheet EST may be improved.

Although the embodiments of the present invention have been described above with reference to the accompanying drawings, the present invention may be applied in other specific forms without changing the technical idea or essential features thereof. Therefore, the above-described embodiments are to be considered in all aspects as illustrative and not restrictive.

1. A stacking device comprising a magazine unit, a sheet transport unit, a sheet alignment unit, and a sheet supply unit,
wherein the magazine unit is configured to supply an electrode sheet,
the sheet transport unit is configured to pick up the electrode sheet and transport the electrode sheet to the sheet alignment unit,
the sheet alignment unit is configured to determine whether the electrode sheet is aligned, the sheet supply unit is configured to stack the electrode sheet on an electrode web,
the sheet supply unit includes a stage on which the electrode sheet is loaded and a feeding roller provided on one side of the stage, and
the feeding roller is configured such that the electrode sheet is detached from the stage and then attached onto the electrode web.

2. The stacking device of claim 1, wherein the sheet supply unit further comprises a rotation portion, the stage is provided on an outer surface of the rotation portion, and the rotation portion is configured to rotate the stage such that the stage is inverted.

3. The stacking device of claim 1, wherein the sheet alignment unit comprises:
an alignment stage on which the electrode sheet is loaded; and
an alignment measuring portion configured to check the alignment between the alignment stage and the electrode sheet.

4. The stacking device of claim 1, wherein the sheet alignment unit further comprises a rotation portion, the alignment stage is provided on an outer surface of the rotation portion, and the rotation portion is configured to rotate the alignment stage such that the alignment stage is inverted.

5. The stacking device of claim 1, wherein the sheet transport unit comprises:
a sheet picking portion configured to pick up the electrode sheet; and
a conveyor configured to transfer the electrode sheet from the magazine unit to the sheet alignment unit.

6. The stacking device of claim 1, wherein the electrode sheet comprises a first electrode layer, the electrode web comprises a second electrode layer, the first electrode layer is one of a positive electrode layer and a negative electrode layer, and
the second electrode layer is another one of the positive electrode layer and the negative electrode layer.

7. The stacking device of claim 6, wherein the electrode sheet further comprises a solid electrolyte layer provided on the first electrode layer.

8. The stacking device of claim 6, wherein the electrode web further comprises a solid electrolyte layer provided on the second electrode layer.

9. The stacking device of claim 1, wherein the electrode web travels in a first direction, and
the electrode web comprises a plurality of electrode tabs arranged along the first direction.

10. A method for manufacturing an all-solid-state battery, the method comprising:
subjecting an electrode web to travel along a first direction;
supplying an electrode sheet onto a stage;
inverting the stage such that the electrode sheet faces the electrode web; and
attaching the electrode sheet onto the electrode web, wherein the electrode sheet is detached from the stage and attached onto the electrode web through a feeding roller provided on one side of the stage.

11. The method of claim 10, wherein the electrode sheet is provided on one surface of the stage, and the stage is inverted such that the one side faces the electrode web.

12. The method of claim 10, wherein the attaching of the electrode sheet comprises stamping the inverted stage onto the electrode web.

13. The method of claim 10, further comprising re-inverting the stage after the attaching of the electrode sheet onto the electrode web.

14. The method of claim 10, further comprising providing a sealing member fixing the electrode sheet attached onto the electrode web.

15. The method of claim 10, wherein the electrode sheet comprises a first electrode layer, the electrode web comprises a second electrode layer, the first electrode layer is one of a positive electrode layer and a negative electrode layer, and
the second electrode layer is another one of the positive electrode layer and the negative electrode layer.
